(19) United States
(12) Patent Application Publication
(10) Pub. No.: US 2002/0060230 A1
(43) Pub. Date: May 23, 2002

(54) Vibrating sureening device for distributing powder with adjustable flow rate

(75) Inventors: Ernst Zysset, Macolin (CH); Friedrich Durand, Solothurn (CH)

Correspondence Address: GRIFFIN & SZIPL, PC, SUITE PH-1, 2300 NINTH STREET, SOUTH, ARLINGTON, VA, 22204, US

(73) Assignee: The Swatch Group Management Services AG, Biel (CH)

(21) Appl. No.: 09/984,188

(22) Filed: Oct. 29, 2001

(30) Foreign Application Priority Data
Nov. 6, 2000 (EP) 00203879.2
Nov. 6, 2000 (EP) 00203877.6

(51) Int. Cl. G01F 1/00

(52) U.S. Cl. 222/189.05; 222/189.02; 222/161

(57) ABSTRACT

The apparatus includes a feed hopper (39), a vibratory module (20) formed by a sieve (26) and by a first transducer (22) associated with a first resonator (21), said transducer (22) receiving an a.c. control voltage V_{com} allowing it to transmit mechanical vibrations to said sieve (26, 26′) in response, means (30, 40) for locking said vibratory module (20) below said hopper (39), and an electronic control unit (50) arranged to supply said control voltage V_{com},. It is characterized in that it further includes a second transducer (24) arranged in proximity to said sieve (26) and in that said control unit (50) includes a stage (55) arranged to receive a measuring voltage Vₘₑₛ. representative of the mechanical vibrations and to adjust the control voltage V_{com} of the first transducer (22) in response so as to enslave the powder flow rate value to a predetermined desired value.

The present invention belongs to the field of vibrating screening devices for distributing powder at an adjustable flow rate. The device according to the invention includes in particular automatic control and enstoring means enabling the flow rate to be kept to a predetermined value, whatever the influence of the external environment, and if necessary preventing the powder becoming clogged in the screening device.

There exist in the prior art a large number of screening devices able to provide fine powders, most often to assure constant size grading, without any risk of clogging in the sieve.

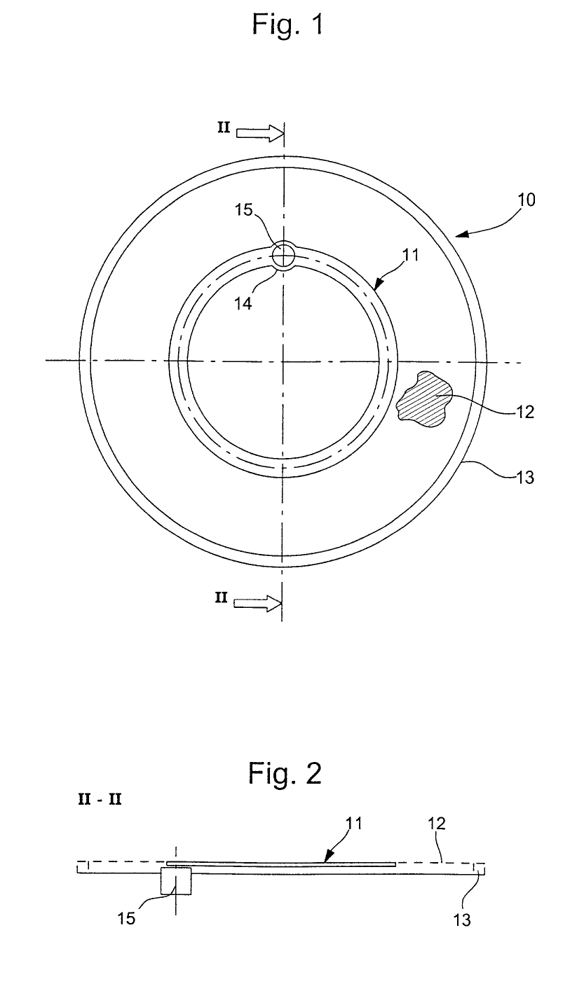

German Patent No. DE 4340948 discloses a screening device designed by the reference 10 in FIGS. 1 and 2 of the present description. It will be noted that FIG. 1 shows a bottom view of screening device 10, and that FIG. 2 shows a cross-section of this device along the axis 11-11 shown in FIG. 1.

Screening device 10 includes a unit (not shown in FIGS. 1 and 2) forming a tank able to contain a powder, a sieve, or sifter or screen 12 carried by a circular frame 13, and an annular vibrating resonator 11 bonded onto the lower face of sieve 12. Resonator 11 includes a flat aluminium ring, and an enlarged zone 14 for securing a piezoelectric transducer 15 which makes resonator 11 resonate, so that sieve 12 starts to vibrate. It will be recalled that making a sieve vibrate ultrasonically prevents the powder or granules from clogging the sieve, so that the powder or the granules can flow through the sieve.

Piezoelectric transducer 15 is powered by a sinusoidal alternating voltage having an amplitude of approximately 1000 V, an output power of approximately 20 W and a frequency comprised between 18 and 42 kHz (ultrasonic range).

A device, such as described above, allows a powder having a size grading determined by the screen mesh to be obtained. It enables a constant powder flow rate to be obtained for a determined mesh size and a determined sieve vibration frequency. However, it does not allow the flow rate to be controlled perfectly, nor does it prevent the formation of bridges of powder above the sieve. Nor does it allow the parameters of the sieve measuring feed apparatus to be modified as a function of external parameters, such as fluctuations in the ambient temperature, hygrometric pressure or atmospheric pressure which may have an effect on the fluidity of the powder or on the operating conditions of the apparatus itself.

One object of the present invention is to provide a sieve measuring feed apparatus which is able to overcome the aforementioned drawbacks, in particular a measuring feed apparatus allowing a powder flow rate to be adjusted with great stability and a high level of reproducibility, and preventing, if necessary, any risk of clogging.

Another object of the present invention is to provide an apparatus allowing powder to be measured independently of variations in external conditions such as fluctuations in the ambient temperature, hygrometric rate and atmospheric pressure.

The invention therefore concerns a powder measuring feed apparatus including a feed hopper, a vibratory module formed by a sieve provided for a determined powder size grading, and by a first transducer associated with a first resonator, said transducer receiving an a.c. control voltage V_{com} allowing it to transmit mechanical vibrations to said sieve in response, means for locking said vibratory module below said feed hopper and an electronic control unit arranged to provide said control voltage V_{com}.

The apparatus is characterised in that it further includes a second transducer arranged in proximity to said sieve or mechanically connected thereto, and in that said control unit includes a stage arranged for receiving from said second transducer acting as a sensor a measuring voltage Vₘₑₛ representative of the mechanical vibrations of said sieve and for adjusting control voltage V_{com} of the first transducer in response so as to enslave the value of the powder flow rate to a predetermined desired value.

According to a significant feature of the invention, the electronic control unit also includes a regulating stage intended to take into account, by means of correspondence or calibration tables, fluctuations in external conditions, for example the temperature, hygrometric degree or pressure, as well as the apparatus' own features and those of the powder to be measured, so as to keep the powder flow rate independent of said parameters.

According to a preferred embodiment, the second transducer is also associated with a second resonator, and the two transducers have the same features and operate alternately to make the sieve vibrate and to pick up the vibrations of said sieve.

According to another feature of the invention, which is particularly useful when the powder to be measured has a significant risk of clogging, the vibratory module also causes a vibrating element, which projects into the median part of the hopper, to vibrate.

Other features and advantages of the present invention will appear more clearly upon reading the detailed description of preferred embodiments of the invention, given solely by way of example, with reference to the annexed Figures in which:

FIG. 1 which has already been cited, shows a bottom view of a screening apparatus according to the prior art;

FIG. 2 which has already been cited, shows a cross-section of the apparatus of FIG. 1 along the line 11-11;

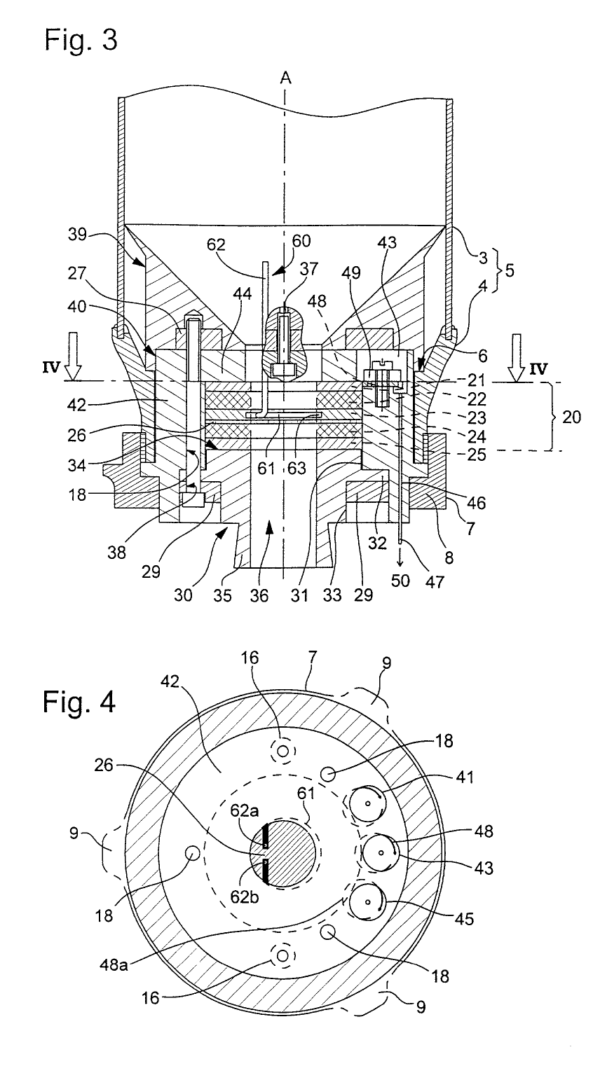

FIG. 3 shows a cross-section along an axial plane of an embodiment of the measuring feed apparatus according to the present invention;

FIG. 4 shows a cross-section of the apparatus of FIG. 3 along the line IV-IV;

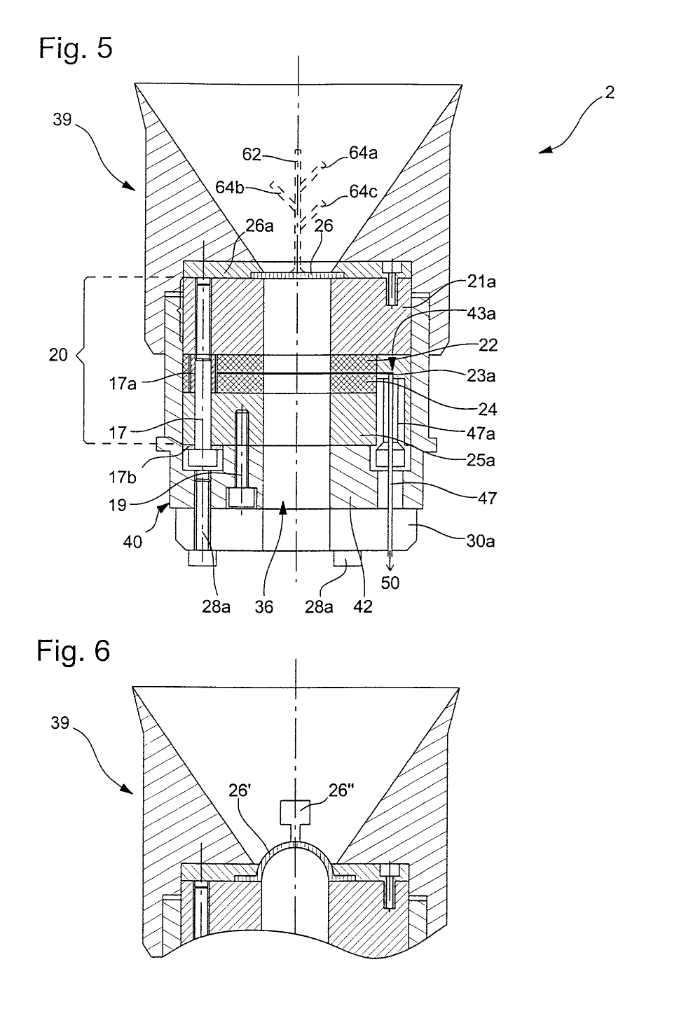

FIG. 5 shows a cross-section of another embodiment of a measuring feed apparatus according to the invention along an axial plane;

FIG. 6 shows an alternative embodiment of the apparatus shown in FIG. 5;

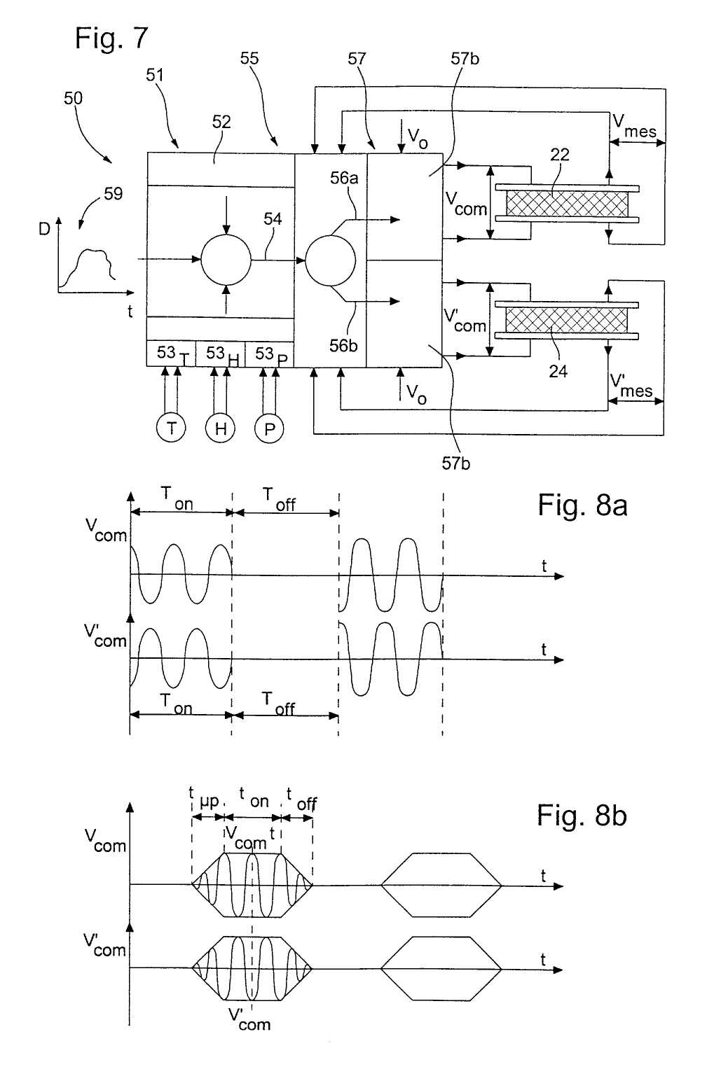

FIG. 7 shows a block diagram of an electronic control unit for a measuring feed apparatus according to the invention; and

FIGS. 8a and 8b show timing diagrams of the voltages which can be used to operate the feed measuring apparatus according to the invention.

FIG. 3 shows a cross-section along an axial plane of a first embodiment of a measuring feed apparatus 1 according to the invention, of generally cylindrical shape around an axis A, and including an outer casing in two parts. The top part 5 is formed by a tube 3, for example made of steel, welded onto a brass base 4 of smaller internal diameter and having at its base an outer threading. The bottom part is formed by a brass ring 7, having on its top part a threading intended to co-operate with the threading of top part 4, and on its base a ring 8 extending radially, slightly beyond the inner wall of brass base 4. Ring 7 is provided with three lugs 9 facilitating the screwing/unscrewing thereof onto base 4 of top part 5, so as to assembly the elements belonging to the vibrating sifter, as will be explained hereinafter.

With reference also to FIG. 4, it can be seen that the outer casing holds together an assembly formed of four main elements, a vibratory module 20, arranged between a bottom locking element 30 and a top locking element 40, also allowing a hopper 39 to be positioned inside tube 3, said hopper abutting an edge 6 of base 4.

In the embodiment shown, vibratory module 20 is formed of two piezoelectric assemblies, the operation of which is controlled by an electronic control unit 50 and which sandwiches a sieve 26. The top piezoelectric assembly, on the side of hopper 39, includes a metal resonator 21, a piezoelectric transducer 22 and a metal ring 23 also forming a resonator and in contact with sieve 26. The bottom piezoelectric assembly, in contact with sieve 26, includes a piezoelectric transducer 24 and a metal resonator 25. Resonators 21, 25 and ring 23, which also supply the control voltages to transducers 22, 24 are connected to electronic control unit 50 by connecting flanges which pass through top locking element 40.

Top locking element 40 includes on the side of hopper 39 a bottom ring 44 having the same opening as the base of hopper 39, and has a thick vertical wall 42 in which are arranged on the one hand mechanical means for assembly to bottom locking element 30, and on the other hand electric means connecting vibratory module 20 with an electronic control unit 50 which will be described hereinafter with reference to FIG. 7.

The mechanical assembling means are formed by three through passages 18 intended to receive three threaded rods 28 for securing top 40 and bottom 30 locking means to each other, as well as two wells 16 the bottom of which is pierced to allow hopper 39 to be fixed thereto by means of screws 37.

The electric connecting means are formed by connecting flanges housed in wells 41, 43, 45 formed at the surface of top locking element 40 in thick wall 42. Along axis A, these wells 41, 43, 45 have passages which communicate with the central part intended to receive the vibratory module, depths corresponding to the staging of resonators 21, 23, 25, and they have a sufficient angular shift with respect to each other for the walls of said wells not to communicate with each other. As can be seen in FIG. 3, the bottom of each well is pierced with a hole 46 for the passage of a conducting rod 47 which opens out outside the base of the top locking element, and which includes, at the other end in a perpendicular plane to said rod 47, a loop 48 a portion 48a of which opens into the central recess to allow a resilient contact with resonators 21, 23, 25. This contact flange, formed by a rod 47 and a loop 48, is secured to the bottom of each well by means of a washer and a screw 49.

Bottom locking element 30 fits into top locking element 40 by means of a top ring 31, the upper bearing surface 34 of which has substantially the same dimensions as the rings of the resonators and piezoelectric transducers. It then comprises a collar 32 provided with three holes 38 facing through passages 18 of top locking element 40, a bottom sleeve 33 of smaller diameter than the upper ring 31, said sleeve 33 being extended by a tubular part 35. For the flow of powder, this bottom locking element 30 includes at its centre a tubular passage 36 of substantially equal cross-section to the useful surface of sieve 26.

These top 40 and bottom 30 locking elements are made of an injection moulded insulating plastic material.

After securing hopper 39 by means of two screws 37 passing through wells 16, and after setting in place vibratory module 20, which clamps sieve 26, the bottom 30 and top 40 locking elements are assembled by means of a three threaded rods 28 which pass through holes 38 of collar 32, and through passage 18 in wall 42. The heads of threaded rods 28 are supported by a bottom blocking ring 29 having three holes for the passage of rods 28 the ends of which are screwed into a top blocking ring 27 arranged in an annular recess 27a of sieve 39. It will be observed that other assembling means are possible, for example by screwing rods 28 directly into thick wall 42 of top locking element 40.

As can be seen, the arrangement which has just been described allows sieve 26 or any of the parts forming vibratory module 20 to be replaced very easily, simply by unscrewing the three threaded rods 28 and without it being necessary to interrupt any electric connection.

As can be seen in FIG. 3, the sieve measuring feed apparatus may also include a rod or bar shaped vibrating element 60. In the embodiment shown, this vibrating element 60 is formed by a base 61 made of a resilient material in the shape of an open loop which is snap into a groove 63 of metal ring 23, said base 61 being extended by two flexible rods 62a, 62b bent at 90° and projecting inside hopper 39. Thus, when an a.c. voltage is applied to one or other of transducers 22, 24, ring 23 starts to vibrate and transmits said vibrations to rods 62a, 62b to allow any formation of arches or bridges at the surface of the powder to be broken. It will be observed that it is also possible, without modifying the construction, to have only one flexible rod. Likewise, the construction which has just been described could apply in the same way to any element of vibratory module 20, provided that such element is located above sieve 26, such as resonator 21 or transducer 22.

Prior to describing the operating features of the measuring feed apparatus according to the invention, another embodiment designated by the general reference 2 will be described more briefly, shown without any outer losing in FIG. 5, in which identical or similar parts are designated by the same references or by related references. It can be seen that top locking element 40 has, in a way been turned over to accommodate vibratory module 20 in its central part, in which sieve 26 is no longer clamped between piezoelectric transducers 22 and 24, but held in a frame 26a screwed onto the outer surface of a resonator 21a, just below the opening of hopper 39. It will also be observed that the resonator which was located between transducers 22 and 24 is replaced by a simple metal disc 23a connected to the negative pole of control unit 50 via a rod 47 which passes through a well 43a formed through resonator 25, having at that point an insulating sleeve 47a, and which also passes through the bottom of thick wall 42. The electrodes of transducers 22 and 24, formed by the contact surfaces of resonators 21a and 25a in contact with each other, are electrically connected to the positive pole of the electronic control unit by means of at least a threaded rod 17 which passes through resonators 21a and 25a and establishes an electric contact between them, also passing through transducers 22 and 24 where an insulating sealing gasket 17a is provided. The head of rod 17 is in contact with a conductive ring 17b which allows the electric connection to be brought to a second well 43b (not shown) in proximity to well 43a. In order to maintain a dynamic cohesion of the assembly, it is preferable for three threaded rods 17 to be provided distributed at 120° around the apparatus. In order to allow the vibratory element to be secured inside element 40, three threaded rods 19 are also provided which passes through the base of said element 40 to be screwed into resonator 25a. This embodiment includes finally a bottom 30a screwed at three points by screws 28a to conceal the openings made in the bottom of element 40.

Another feature of this second embodiment is also that bottom resonator 25a is made of a metal having a greater specific density than that of the metal of top resonator 21a. Steel will for example be used for resonator 25a and aluminium or an aluminium alloy will be used for resonator 21a.

In the embodiment shown in FIG. 5 it can be seen that vibrating rod 62 is secured, for example by welding, to the centre of sieve 26, screws 37 having been omitted to make the drawing clearer. It will also be observed that ring 23, which was used to hold vibrating element 60, is replaced by a simple contact ring 23a. FIG. 5 also shows a variant wherein the flexible rod includes at intervals radial extensions 64a, 64b, 64c . . . etc. which contribute to breaking the arches and bridges even more easily, whatever the level of powder in hopper 39. It is of course evident that this embodiment and this variant are also applicable to the case in which sieve 26 is changed between two resonators 21, 25.

In either embodiment, mechanical deformation imposed by the axial vibration of piezoelectric transducers 22 and 24 are absorbed and/or released by the resilient deformation of connecting rods 17 or 28.

FIG. 6 shows an alternative embodiment of the screening device of FIG. 5, wherein said sieve 26′ has a dome shape which gives the sieve better mechanical resistance and stabilises the deformation thereof which reduces the risk of clogging. The tip of the dome-shaped sieve includes a vibration sensor 26″ which may also be connected to electronic control unit 50 for controlling piezoelectric transducers 22 and 24. Of course, a sieve of such shape is also compatible with the embodiment corresponding to FIGS. 3 and 4.

In the preceding description, no distinction is made as regards the respective functions of the piezoelectric transducers, which are preferably identical to facilitate calibrating electronic control unit 50, and to increase the precision of the measuring feed apparatus. According to a basic embodiment, a transducer acts as a vibrator and the other transducer as a vibration sensor. As will be explained hereinafter, according to a preferred embodiment, the two transducers 22 and 24 have alternating loop operating mode. During a first period a transducer, for example transducer 22, receives a train of pulses controlled by an a.c. voltage V_{com} supplied by electronic control unit 50 to make sieve 26 or 26′ vibrate along axis A. During the same period the other transducer 24 acts as a vibration sensor and supplies a measuring voltage V′ₘₑₛ to electronic control unit 50, which will, if necessary, adjust in response voltage V′_{com} for the next period. In the next period the operating modes of transducers 22 and 24 are reversed and correspond to voltages V′_{com} and Vₘₑₛ. The alternation of voltages V′_{com} and V′_{com} is shown schematically in FIG. 8a.

With reference now also to FIG. 7, which shows the block diagram of electronic control unit 50, it can be seen that different stages exist, allowing the features of the apparatus, those of its operation modes, and external conditions to be taken into account to obtain as a function of time t a flow rate D of powder determined for example by the diagram designated by the reference 59 in FIG. 7. The data of this diagram are integrated in a first regulating stage 51 which also includes a module 52 acting on the apparatus' own features, for example when a sieve 26 or 26′ is replaced by a new sieve, a sieve having a different mesh aperture or when a new powder is used having different features. It also includes a module 53 which, by means of correspondence or calibration tables 53_{T}, 53_{H}, 53_{P}, deriving from values received from sensors for the temperature T, hygrometric degree H and environment pressure Pin which the apparatus is operating, allow a control signal 54 to be supplied to the next stage 55. Stage 55 also receives from each transducer 22, 24, a measuring voltage Vₘₑₛ, V′ₘₑₛ to supply in response control signals 56a, 56b to the next stage 57. In the event that force sensor 26″ is located on the sieve itself (see FIG. 6) it will be observed that stage 55 can only receive a single measuring voltage Vₘₑₛ, supplied only by said sensor 26″. Stage 57 includes two power stages 57a and 57b respectively receiving control signals 56a, 56b and a supply voltage Vo to supply respectively to each sensor 22, 24 a control voltage V_{com}, V′_{com} in accordance with an alternation which was explained at the beginning with reference to the timing diagram of FIG. 8.

Such an electronic control unit 50 has the advantage of being able to enslave the powder flow rate to a value which is predetermined from the mechanical vibrations supplied to the sieve, i.e. from the control voltage and the measuring voltage which are adjusted and adjustable to a frequency equal to the resonant frequency of all the vibrating elements of the apparatus.

This electronic control unit 50 also allows flow rate variations due to modifications in external conditions such as the temperature, hygrometric degree and atmospheric pressure or an artificially applied pressure in the tank to be minimised or totally removed.

According to an advantageous embodiment, as shown by the timing diagram of FIG. 8b, electronic control unit 50 can contain a control voltage time programming, so as to have for example trains of vibrations having a rising ramp during a time tᵤₚ, then a plateau for a time ton and finally a downward ramp during a time t_{off}, voltages V_{com} and V′_{com} having their positive and negative alternations in opposition to each other.

The present invention has essentially been described with reference to piezoelectric transducers. It is evident that other types of transducers may be used without departing from the scope of the present invention, such as electromagnetic transducers.

What is claimed is:

1. A powder measuring feed apparatus including a feed hopper, a vibratory module formed by a sieve provided for a determined powder size grading and by a first transducer associated with a first resonator, said transducer receiving an a.c. control voltage V_{com} allowing it to transmit mechanical vibrations to said sieve in response, means for locking said vibratory module below said hopper, and an electronic control unit arranged to provide said control voltage V_{com}, wherein it further includes a second transducer arranged in proximity to said sieve or in mechanical connection therewith, said first and second transducers operating alternately to make the sieve vibrate and to pick up the vibrations from said sieve and in that said control unit includes a stage arranged to receive a measuring voltage Vₘₑₛ. representative of the mechanical vibrations of said sifter and to adjust the control voltage V_{com} of the first transducer in response so as to enslave the powder flow rate value to a predetermined desired value.

2. A measuring feed apparatus according to claim 1, wherein the control unit also includes a regulating stage for taking account, by means of correspondence or calibration tables (53_{T}, 53_{H}, 53ₚ) of fluctuations in external conditions, such as the temperature, hygrometric degree or pressure, as well as the apparatus' own features in order to keep the powder flow rate independent of said parameters.

3. A measuring feed apparatus according to claim 1, wherein the second transducer is also associated with a second resonator and in that the two transducers have the same operating features.

4. A measuring feed apparatus according to claim 1, wherein the two transducers are piezoelectric transducers.

5. A measuring feed apparatus according to claim 1, wherein the vibratory module also causes a vibrating element (60), including a flexible rod (62) projecting into the median part of the hopper, to vibrate.

6. A measuring feed apparatus according to claim 5, wherein the flexible rod further includes, at intervals, radial extensions.

7. A measuring feed apparatus according to any of claim 1, wherein the transducers and the resonators are in the shape of rings of the same dimensions, held in place between bottom locking means and top locking means (40) screwed together and having a central recess for the passage of the powder.

8. A measuring feed apparatus according to claim 3, wherein the resonators are metal units screwed together, the bottom unit having a higher density than that of the top unit.

9. A measuring feed apparatus according to claim 1, wherein the sieve is gripped between the two transducers.

10. A measuring feed apparatus according to claim 1, wherein the sieve is fixed immediately below the hopper.

11. A measuring feed apparatus according to claim 1, wherein the sieve (26) is disc-shaped.

12. A measuring feed apparatus according to claim 1, wherein the sieve is dome-shaped.

13. A measuring feed apparatus according to claim 12, wherein the sieve further includes at the top of the dome, a vibration sensor.
